(19) United States
(12) Patent Application Publication
(10) Pub. No.: US 2017/0076069 A1
(43) Pub. Date: Mar. 16, 2017

(54) SECURE NETWORK-BASED SYSTEM FOR COMMUNICATION OF CLINICAL DATA

(71) Applicant: Fresenius Medical Care Deutschland GmbH, Bad Homburg (DE)

(72) Inventors: Ulrich Moissl, Karben (DE); Peter Eifler, Bad Vilbel (DE)

(21) Appl. No.: 15/250,349

(22) Filed: Aug. 29, 2016

(30) Foreign Application Priority Data
Sep. 10, 2015 (DE) 10 2015217359.3

(51) Int. Cl. G06F 19/00; H04L 29/06

(52) U.S. Cl. CPC G06F 19/3481; G06F 19/3418; H04L 63/029; H04L 63/0428; H04L 63/10; H04L 63/083

(57) ABSTRACT

A network-based electronic therapy monitoring system includes: at least one database server configured for storing patient data and therapy data, wherein the database server is arranged within a protected subnet of a data transfer network, the protected subnet being protected by a firewall; at least one server arranged in the data transfer network outside of the protected subnet; and at least one client assigned to a therapy device and/or to a patient, wherein the at least one client is also arranged outside the protected subnet; wherein the at least one client is configured to push therapy data and/or patient data to the at least one server; and wherein the at least one database server is configured to pull therapy data and/or patient data from the at least one server.

### CROSS-REFERENCE TO RELATED APPLICATIONS

Priority is claimed to German Patent Application No. DE 10 2015217359.3, filed on Sep. 10, 2015, the entire disclosure of which is hereby incorporated by reference herein.

### BACKGROUND

The security of patient data but also the security of devices is a huge problem in many fields of biomedical engineering.

It can for example be noted that a lot of data are no longer (only) stored in hard copy, but increasingly stored and processed electronically. The advantage of this is that the respective data are now quickly accessible in many places and for many purposes. In order to allow this, many devices are connected with each other via data transfer networks, such as e.g. the Internet.

However, the danger of unauthorized access rises with the degree of networking.

Therefore numerous precautions are taken to prevent unauthorized access to data and devices.

For instance, so-called firewalls are utilized. Firewalls provide the opportunity e.g. in data transfer networks such as the Internet to limit access directions as well as access applications. I.e. the data transfer network is divided into a part that is viewed as a protected area “behind” the firewall and an unprotected area “in front of” the firewall.

In the field of biomedical engineering, firewalls are configured particularly restrictively, so that e.g. any access from the outside is blocked. Furthermore, often only selective applications from the inside are allowed access to the outside. For example, access to the outside from behind the firewall may only be allowed on certain ports (corresponding to the applications) to limit or completely prevent infiltration of computers behind the firewall with malicious software.

This leads to the problem that access from the “outside” is practically impossible and the access from the “inside” is strictly limited.

If data from therapy devices and/or patients that are situated outside the firewall are to be stored e.g. in a database for patient data and/or therapy data, access is not possible.

In principle, this would be possible by opening the access direction and/or by opening the corresponding ports, but opposed to that are the security considerations pointed out above.

Occasionally, sending treatment reports via email has been tried in the past. However, this form of individual transmission has turned out to be suitable only to a limited extent, since patients often indicated wrong destinations and patients often had no confirmation concerning the receipt of their treatment reports in the right place.

### SUMMARY

In an exemplary embodiment, a secure network-based system for communication of clinical data includes: at least one database server configured for storing patient data and therapy data, wherein the database server is arranged within a protected subnet of a data transfer network, the protected subnet being protected by a firewall; at least one server arranged in the data transfer network outside of the protected subnet; and at least one client assigned to a therapy device and/or to a patient, wherein the at least one client is also arranged outside the protected subnet; wherein the at least one client is configured to push therapy data and/or patient data to the at least one server; and wherein the at least one database server is configured to pull therapy data and/or patient data from the at least one server.

In another exemplary embodiment, a method for securely communicating clinical data in a network-based system includes: receiving, by at least one server arranged in a data transfer network outside of a protected subnet protected by a firewall, therapy data and/or patient data pushed from at least one client also arranged in the data transfer network outside the protected subnet; buffering, by the at least one server, the received therapy data and/or patient data; receiving, by the at least one server, a request for therapy data and/or patient data with reference to at least one patient and/or at least one client from at least one database server arranged in the data transfer network within the protected subnet; and sending, by the at least one server, the requested therapy data and/or patient data to the at least one database server.

In yet another exemplary embodiment, a method for securely communicating clinical data in a network-based system includes: sending, by at least one database server arranged within a protected subnet of a data transfer network protected by a firewall, a request for therapy data and/or patient data with reference to at least one patient and/or at least one client and/or a therapy center to at least one server arranged in the data transfer network outside of the protected subnet; and receiving, by the at least one database server, the requested therapy data and/or patient data from the at least one server.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a schematic overview of an exemplary system in accordance with embodiments of the invention; and

FIG. 2 illustrates a schematic flowchart for exemplary processes in accordance with embodiments of the invention.

### DETAILED DESCRIPTION

Exemplary embodiments of the invention provide an improved network-based therapy system that provides secure communication also under difficult network conditions.

In an exemplary embodiment, a network-based electronic therapy monitoring system which comprises a data transfer network. The data transfer network comprises at least one subnet that is protected by a firewall. Furthermore, the system comprises at least one database server for storing patient data and therapy data, wherein the database server is arranged within the protected subnet. Moreover, the system comprises at least one server outside the protected subnet. Furthermore, the system comprises at least one client that is assigned to a therapy device and/or a patient, whereby the client is also arranged outside of the protected subnet. The client is configured to transfer therapy data and/or patient data to the server via a push mechanism, and the database server is configured to retrieve therapy data and/or patient data from the server via a pull mechanism.

In further exemplary embodiments, corresponding methods are performed on the server and/or on the database server.

Subsequently, exemplary embodiments of the invention will be presented in greater detail with reference to the figures. It is to be noted that different aspects will be depicted that can be employed individually or in combination with each other. For example, any aspect can be utilized with different embodiments of the invention if it is not explicitly presented simply as an alternative.

Moreover, to simplify matters hereinafter normally only one entity will be referred to. Unless explicitly stated otherwise, the invention may also comprise several of the concerned entities respectively. In this respect, the usage of the terms “a” or “an” is only indicative as to that in a simple embodiment at least one entity is used.

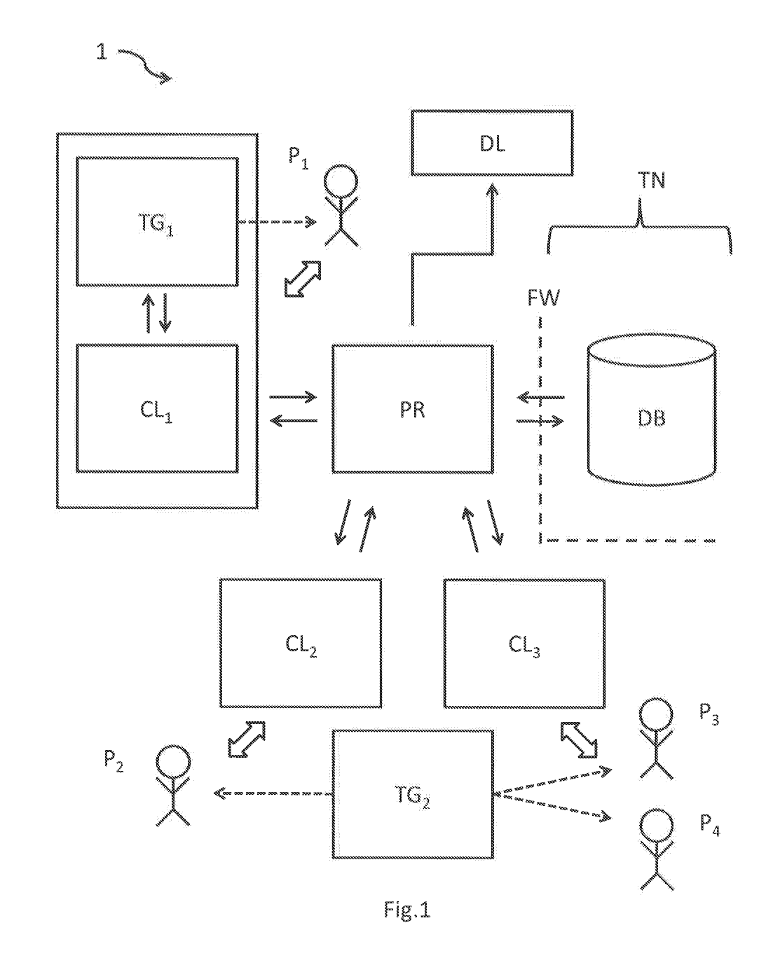

A network-based electronic therapy monitoring system 1 according to the present invention is illustrated schematically in FIG. 1. The network-based electronic therapy monitoring system 1 comprises a data transfer network. This data transfer network can be composed differently and comprise for instance wireless connections as well as wired connections. Various different implementations for the hardware of the data transfer network may be used. An exemplary data transfer network is for example the Internet.

Typically, the data transfer network can be divided into different subnets. Such subnets may be local networks that are provided for communication in home environments but also in companies and public institutions. These subnets can then be connected to other networks via gateways.

In the example depicted in FIG. 1, the data transfer network comprises at least one subnet TN that is protected by a firewall FW. The firewall FW is exemplified by a dotted line.

As described above, the firewall FW protects the subnet TN against unauthorized external access (i.e. access operations that are initiated from the outside), and can additionally be configured so that only certain applications from the inside have access to the outside (i.e. from the subnet TN to the external data transfer network area). An exemplary protected subnet TN is for instance the network of a hospital.

Furthermore, in the exemplary system depicted in FIG. 1, at least one database server DB for storing patient data and therapy data is provided, wherein the database server DB is arranged within the protected subnet TN. In other exemplary implementations, the function of the depicted database server DB may be distributed among multiple different database servers.

Since the subnet TN is arranged as being protected behind a firewall, it is not permitted to simply transfer patient data and/or therapy data from the outside to the database server DB within the subnet TN. For example, one or more clients CL₁, CL₂, CL₃ that are assigned to one or more therapy devices TG₁, TG₂ and/or one or more patients P₁, P₂, P₃ who are also arranged outside the protected subnet TN, cannot send data proactively to the database server DB.

Exemplary embodiments of the invention enable sending of data from outside the protected subnet TN to the database server DB by providing at least one server PR outside the protected subnet TN.

In an exemplary embodiment, the one or more clients CL₁, CL₂ CL₃ assigned to one or more therapy devices TG₁, TG₂ and/or one or more patients P₁, P₂, P₃ can transfer therapy data and/or patient data to the server PR via a push mechanism. Additionally, the database server DB is configured so that therapy data and/or patient data can be retrieved from the server PR via a pull mechanism.

In an exemplary implementation, the therapy device TG₁ is a (home) dialysis machine, and data with reference to a dialysis treatment can be transferred to the server PR during the treatment and/or after the end of the treatment. Thereby the data can be collected automatically and/or entered manually.

In one example (as depicted in FIG. 1), if a client CL₁ has been integrated into a therapy device TG₁ and is only intended for the treatment of a single patient P₁, it is possible to assign the patient P₁ directly to the device TG₁. And, the data relating to the patient P₁ may be collected automatically and be transferred to the server PR via the data transfer network whilst the firewall does not need to be changed.

In another example, if the client CL₁ was not integrated into the therapy device TG₁, the patient P₁ could send data concerning a received treatment to the server PR via a different process. For example, the patient P₁ may use an app for a smartphone or a tablet computer or a suitable web interface to provide treatment data to the server PR. In other examples, other processes for information transfer may be used. For instance, the data may be transferred to the server PR via an email (such as a preformatted email) or another message system (such as a text message, e.g. SMS).

In another exemplary implementation, where a dialysis center treats several patients P₂, P₃, P₄ at a therapy device TG₂, a similar process for providing treatment information to the database server DB via the server PR is provided.

Here, for example, an identification by entering patient data or importing patient data (e.g. from a patient card/electronic health card, etc.) may take place before or after a treatment. For example, a patient P₂ can be directly identified via the client CL₂, whereas additional information is required for CL₃ to identify the patient P₃ or P₄, e.g. by manually entering patient data or by importing a patient card, etc.

Afterwards, the data with reference to the treatment can be collected automatically and be transferred to the server PR via the data transfer network whilst the firewall does not need to be changed.

Within this arrangement the firewall FW can be “opened”, since the database server DB starts a request from the inside to the server PR. Thus, the integrity of the protected subnet TN can be preserved. As the access takes place from the inside, it is also possible to provide an appropriate port for the transfer. For instance, the request to the database server DB via SOAP or REST can be implemented on a suitable port, such as e.g. port 80 (HTTP) or 443 (HTTPS) or another port (e.g. 1143).

In an exemplary embodiment, both the one or more clients CL₁, CL₂, CL₃ and the server PR may be configured to alternatively or additionally transfer encrypted therapy data and/or encrypted patient data to the server PR. Exemplary encryption techniques may be symmetrical or asymmetrical encryption systems, including for example SSL keys or PGP keys that are used in S/MIME, PGP/INLINE, PGP/MIME and/or HTTPS access operations. These keys can be either created by a certification authority or they can be self-signed.

This enables patient data and/or therapy data to be securely transferred without unauthorized access within the data transfer network that is not protected by the firewall FW.

Alternatively or additionally, it may also be provided that the server PR and the database server DB are configured respectively to encrypted transfer therapy data and/or encrypted patient data to the database server DB via a pull mechanism.

Here again, secured connections such as HTTPS can be used accordingly.

It will be appreciated that the execution of the various machine-implemented processes and steps described herein may occur via the computerized execution of processor-executable instructions stored on a tangible, non-transitory computer-readable medium, e.g., RAM, ROM, PROM, volatile, nonvolatile, and/or other electronic memory mechanism. Thus, for example, the operations performed by the database server, firewall, the server outside the firewall, the client devices, and the treatment devices may be carried out according to instructions stored on and/or applications installed on respective computing devices.

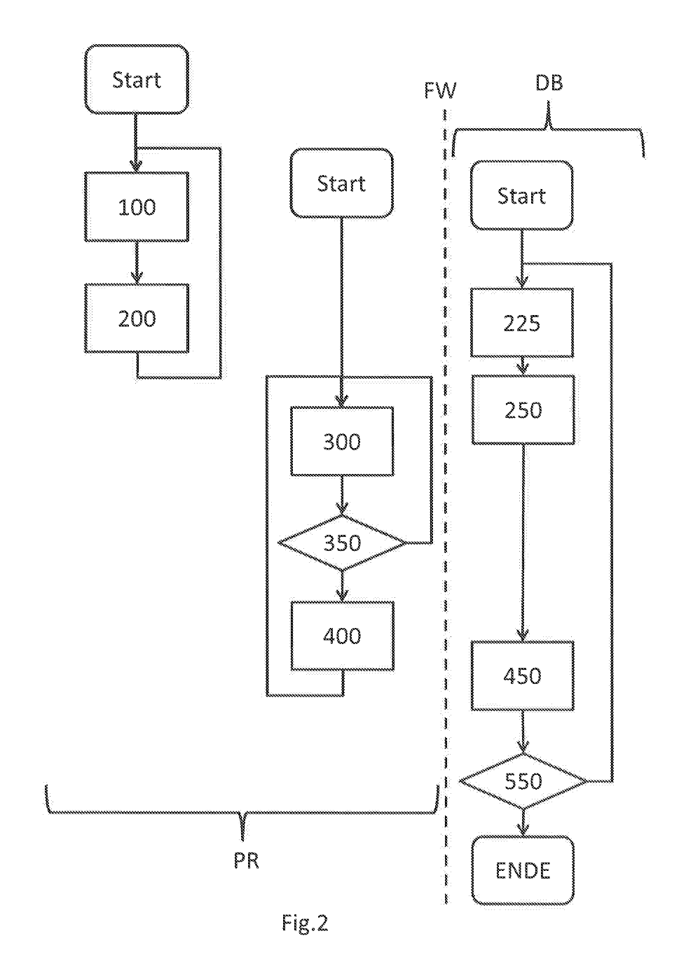

Exemplary methods are illustrated in connection with FIG. 2.

In FIG. 2, different methods are arranged in a way such that the interlocking of steps of different methods can become evident. Whereas methods in connection with the server PR can be found on the left hand side and in the middle, a method in connection with the database server DB is illustrated on the right hand side. By way of distinction, the firewall FW is marked as a dotted line, so that methods that are arranged in the “unprotected” area of the data transfer network are illustrated on the left hand side of the firewall FW, whereas methods that are arranged in the “protected” area of the data transfer network, i.e. in the subnet TN, are illustrated on the right hand side of the firewall FW. The method steps are arranged in a way such that the method steps that are arranged further down are in consecutive chronological order according to an exemplary embodiment.

In an exemplary method according to the present invention for a server PR in a network-based electronic therapy system 1, therapy data and/or patient data are received in a step 100 from one or more clients CL₁, CL₂, CL₃, whereby the therapy data and/or patient data are transferred to the server PR via a push mechanism. Afterwards, the received data are buffered in a suitable storage device in a step 200. Buffering may take place until the data are once downloaded. In an exemplary embodiment, it may also be provided that the data or part of the data, e.g. non-patient related data, are continuingly saved. In another exemplary embodiment, it may be provided that data, or part of the data, are deleted after server-induced retrieval from the database server DB.

After the data has been buffered, further data can be received. Several of these processes can run in parallel with reference to several patients. Therefore this sub-process has been specified as stand-alone in FIG. 2. As indicated above, patient allocation may apply by a certain therapy device such as TG₁ being assigned to only a single patient P₁.

Now a request for therapy data and/or patient data can be received by a database server DB in a step 300. Subsequently, in a step 400 the requested therapy data and/or patient data with reference to one or more patients P₁, P₂, P₃ and/or one or more clients CL₁, CL₂, CL₃ can be sent to the database server DB.

Several of these processes can run in parallel with reference to several patients. Therefore this sub-process has been specified as stand-alone in FIG. 2.

In an exemplary embodiment, the therapy data transfer with reference to a patient, e.g. P₁, to the server PR may be carried out without the transfer of patient data and only with the transfer of data with reference to the therapy device TG₁. Then e.g. a patient therapy device allocation is stored in a further database (not shown) (P₁<->TG₁), so that also a request from the database server DB for data with reference to a certain patient P₁ can be correlated and processed.

In an exemplary embodiment where a dialysis center treats several patients P₂, P₃, P₄ at a therapy device TG₂, a similar process for providing treatment information to the database server DB via the server PR is provided. Here for example, an identification by entering patient data or importing patient data (e.g. from a patient card/electronic health card, etc.) may take place before or after a treatment. For example, a patient P₂ can be directly identified via the client CL₂, whereas additional information is required for CL₃ to identify the patient P₃ or P₄, e.g. by manually entering patient data or by importing a patient card, etc.

Afterwards, the data with reference to the treatment can be collected automatically and be transferred to the server PR via the data transfer network whilst the firewall does not need to be changed.

Similarly, it can also be provided that e.g. a certain client CL₁, CL₂, CL₃ is always assigned to one patient P₁, P₂, P₃ or always one therapy device. This can be accomplished by a corresponding configuration, e.g. via a unique identifier—such as an appropriate cookie, a mobile phone number, etc. It will be appreciated that such an assignment can take place during receiving or buffering. It can also take place later on during a data request.

In a respective method according to the present invention for a database server DB in a network-based electronic therapy system 1, first a request for therapy data and/or patient data and/or data of a therapy center is sent to a server PR in a step 250. The request is processed as described above by the server PR and the requested therapy data and/or patient data with reference to the one or more patents P₁, P₂, P₃ and/or the one or more clients CL₁, CL₂, CL₃ are received by the database server DB from the server PR in a step 450.

It can also be provided that the one or more patients P₁, P₂, P₃ are assigned to one or more therapy devices TG₁, TG₂ and/or the one or more patients P₁, P₂, P₃ are assigned to one or more clients CL₁, CL₂, CL₃ and/or the one or more clients CL₁, CL₂, CL₃ are assigned to one or more therapy devices TG₁, TG₂ within the protected subnet TN. The assignments described above in the context of the server PR can be made alternatively or additionally by the database server. Thus, it will be appreciated that the system permits an almost complete decoupling of patient data and therapy data so that, for example, patient data can only remain within the protected subnet TN. If data of a therapy center are transferred, it will be appreciated that complete groups of data can be preselected and transferred.

In a further exemplary embodiment, the step 250 of sending a request is repeated periodically. For this purpose, a suitable condition for a time schedule 550 can be implemented, so that the method is repeated periodically, e.g. every day.

In a particular example, it may be provided that the repeat rate of the request 250 follows the repeat rate of the therapy of one or more patients P₁, P₂, P₃ or corresponds to it. For example, if a patient P₁ requires daily therapy, the data are retrieved daily, whereas if a patient P₂ requires therapy only once every 3 days, the retrieval takes place only once every 3 days. Thus the network load due to unnecessary traffic can be reduced. Furthermore, the load of the server PR can be reduced since it does not need to process as many requests and does not have to answer, for example, data requests for non-existing data negatively in the meantime.

In a further exemplary embodiment, in order to further increase the security of the server PR, it may be provided that the database server DB is required to authorize the server PR. For this it may be provided that the server PR needs to be authorized by entering a passphrase in a preceding step 350 before sending the requested therapy data and/or patient data in step 400. It may also be provided that, as soon as step 350 has been executed successfully once, this authorization will be valid for a request session and/or a predefined period of time before having to be repeated.

Furthermore, in an exemplary embodiment, it may also be provided that alternatively or additionally the pull port at the database server must be activated via port-knocking in a step 225 before the database server DB sends a request for therapy data and/or patient data.

Such a measure prevents denial-of-service attacks that can be detected time and again to crash servers or to force them to grant access to data. This increases the system availability and, in addition, strengthens the security.

In a further exemplary embodiment, the server PR further analyzes the therapy data with reference to the one or more therapy devices TG₁, TG₂ in order to determine whether maintenance of the therapy device is necessary, whereby, if maintenance is required, a corresponding notification is provided.

This may increase the availability of the therapy devices and thus also the patient compliance.

Thereby the notification can be provided for the respective client, e.g. integrated into the therapy device or separately, and/or a client of the maintenance staff. The data transfer network may be used for sending the notification. For instance, a respective message can be displayed on a web page or in an app. Alternatively or additionally it can also be provided that the notification is provided for a maintenance provider DL for the therapy device TG₁, TG₂, TG₃.

It will be appreciated that it is not necessary to make patient data available for a notification to a maintenance provider DL. For example, for creating notifications it is sufficient to analyze (anonymous) therapy data with reference to a therapy device. From this it is possible to derive whether individual parts need to be exchanged or consumables need to be replenished.

Exemplary embodiments of the invention provide (mobile) clients with the ability to transfer data to a database server in a clinical environment that is protected by a firewall. Thereby the server PR works similarly to a proxy server. In an exemplary embodiment, the server PR can be a suitably configured web server.

Via the client that is either integrated into a therapy device or operated by a patient or other persons, treatment reports can be passed to the server PR, for example.

It is advantageous that in the system according to exemplary embodiments of the present invention, data forwarding in standardized form is enabled and thus the security of the data transfer is increased. A patient can be sure that their data has been received by the server PR. Moreover, the system allows for the statistical analysis of patient data. Thereby therapy data of a multitude of patients and (anonymized) patient data can be retrieved from the server PR. Instead of the database server DB, the data can also be retrieved from another instance via the same or similar mechanisms.

It is also possible that such statistical analyses may be carried out on the server PR and only the results are provided.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of“or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A secure network-based system for communication of clinical data, comprising
at least one database server configured for storing patient data and therapy data, wherein the database server is arranged within a protected subnet of a data transfer network, the protected subnet being protected by a firewall;
at least one server arranged in the data transfer network outside of the protected subnet; and
at least one client assigned to a therapy device and/or to a patient, wherein the at least one client is also arranged outside the protected subnet;
wherein the at least one client is configured to push therapy data and/or patient data to the at least one server; and
wherein the at least one database server is configured to pull therapy data and/or patient data from the at least one server.

2. The system according to claim 1, wherein the at least one client and the at least one server are configured such that the therapy data and/or patient data pushed from the at least one client to the at least one server is encrypted.

3. The system according to claim 1, wherein the at least one server and the at least one database server are configured such that the therapy data and/or patient data pulled from the at least one server by the at least one database server is encrypted.

4. A method for securely communicating clinical data in a network-based system, comprising:
receiving, by at least one server arranged in a data transfer network outside of a protected subnet protected by a firewall, therapy data and/or patient data pushed from at least one client also arranged in the data transfer network outside the protected subnet;
buffering, by the at least one server, the received therapy data and/or patient data;
receiving, by the at least one server, a request for therapy data and/or patient data with reference to at least one patient and/or at least one client from at least one database server arranged in the data transfer network within the protected subnet; and
sending, by the at least one server, the requested therapy data and/or patient data to the at least one database server.

5. The method according to claim 4, wherein before sending the requested therapy data and/or patient data, the method further comprises:
entering a passphrase to allow access to the at least one database server.

6. The method according to claim 4, wherein before receiving the request for therapy data and/or patient data, the method further comprises:
performing port knocking such that a pull port of the at least one database server is activated.

7. The method according to claim 4, further comprising:
analyzing, by the at least one server, received therapy data with reference to a therapy device;
determining whether maintenance of the therapy device is needed; and
providing, in response to determining that maintenance is needed, a corresponding notification.

8. The method according to claim 7, wherein the corresponding notification is provided to client corresponding to the therapy device.

9. The method according to claim 7, wherein the corresponding notification is provided to a maintenance service provider for the therapy device.

10. A method for securely communicating clinical data in a network-based system, comprising:
sending, by at least one database server arranged within a protected subnet of a data transfer network protected by a firewall, a request for therapy data and/or patient data with reference to at least one patient and/or at least one client and/or a therapy center to at least one server arranged in the data transfer network outside of the protected subnet; and
receiving, by the at least one database server, the requested therapy data and/or patient data from the at least one server.

11. The method according to claim 10, wherein sending requests for therapy data and/or patient data is repeated periodically.

12. The method according to claim 11, wherein a repeat rate for sending requests for therapy data and/or patient data corresponds to a repeat rate of a therapy for a patient.
